(19) United States
(12) Patent Application Publication
(10) Pub. No.: US 2013/0142974 A1
(43) Pub. Date: Jun. 6, 2013

(54) PLASTICS PREFORM FOR LARGE-VOLUME CONTAINERS AND PROCESS AND DEVICE FOR PRODUCING THIS PREFORM

(71) Applicant: Jochen Mitzler, Dachau (DE)

(72) Inventor: Jochen Mitzler, Dachau (DE)

(73) Assignee: KRAUSSMAFFEI TECHNOLOGIES GMBH, Muenchen (DE)

(21) Appl. No.: 13/813,885

(22) PCT Filed: Aug. 2, 2011
(86) PCT No.: PCT/EP2011/003864

§ 371 Date: Feb. 1, 2013

(30) Foreign Application Priority Data
Aug. 4, 2010 (DE) 10 2010 033 391.3

(51) Int. Cl. B29B 11/14

(52) U.S. Cl. CPC B29B 11/14
USPC 428/35.7; 264/255; 425/576

(57) ABSTRACT

A plastics preform for an inflatable large-volume container, in particular for a container with capacity of at least 5 liters, preferably at least 10 liters, has a closure region and an inflatable hollow body region. For reducing cycle time, the preform, or at least the inflatable hollow body region thereof, is composed of a plurality of layers, where the thickness of each layer is at least 2 mm, preferably at least 3 mm, and where the thickness of the individual layers is in essence identical. Multicomponent injection moulding technology can thus be used with the rotating table technique or with the indexing plate technique to produce the various layers simultaneously in a plurality of injection units in such a way as to give, after each shot, a finished thick-walled preform. Also described are a process for producing the plastics preform and an injection moulding machine.

The invention relates to a plastics parison (preform) for inflatable large-volume containers, in particular of a container with a capacity of at least 3 litres or respectively at least one gallon, preferably at least 15 litres or respectively at least 5 gallons, wherein the plastics parison has a closure region and an inflatable hollow body region. The invention relates in particular to a thick-walled plastics parison (preform) for 5 gallon water bottles or comparable thick-walled plastics parisons. It is also able to be provided for containers with an even greater volume in the inflated state. The invention relates furthermore to a process and an injection moulding machine for the production of the plastics parisons according to the invention.

In the production of plastics containers it is known, in a first step, to initially produce a plastics parison, also designated a preform, by means of an injection moulding process and, in a subsequent step, to inflate the plastics parison to the finished plastics container in a blow moulding machine. The process steps of injection moulding and of blow moulding can be integrated in one machine. In this case, one speaks in terms of single-step injection stretch blow moulding. However, in particular for productions with high outputs, a two-step process is preferred, in which the plastics parisons (preforms) are produced in an injection moulding machine, and at a later time these plastics parisons are inflated to the finished plastics container on a separate blow moulding machine. In this case, one speaks in terms of two-step injection stretch blow moulding.

It is known from U.S. Pat. No. 6,352,426B1 to produce multi-layered PET preforms by means of a multi-component injection moulding machine with rotating table technique, wherein in a first step the actual PET preform is produced and the latter is subsequently covered with one or more barrier layers. The wall thickness of the final preform is determined substantially by the wall thickness of the PET preform produced in the first step. The layer thicknesses of the barrier layers only account for a fraction of the layer thickness of the initially produced PET preform.

From EP0688651A1 the production of preforms is known which consist of a first layer of a first material and a second layer of a second material. A multi-component injection moulding machine with rotating table technique likewise comes into use here. Further details concerning the materials used and the layer thicknesses are not mentioned in this publication.

WO03/055663A1 discloses the production of preforms, wherein two mould halves are moved open and closed transversely to the longitudinal axis of the preform, so that in the closed state of the two mould halves, a cavity is formed for a preform.

In addition, preforms of considerable dimensions are known, which are required specifically for the stretch blow moulding of large-volume plastics containers. For example, thick-walled PET preforms are known for the production of 5-gallon water containers. These PET preforms have a mass of approximately 400 g-750 g, a wall thickness of approximately 8 to 10 mm, and have a length of approximately 400 mm.

In contrast to this, preforms for conventional commercially available drinks bottles with a capacity of 1-2 litres have distinctly smaller dimensions.

Proceeding from the above-mentioned prior art, the invention is based on the problem of indicating a plastics parison, i.e. a preform, which is specifically suited for the production of plastics containers having a large capacity, and which can be produced with a comparatively short cycle time. Furthermore, the invention is based on the problem of indicating a method and a device for the production of this plastics parison.

The solution of the first-mentioned problem takes place through a plastics parison having the features of claim 1. Solutions with regard to the process and the device are indicated in claims 9 and 15. Advantageous embodiments and further developments are found in the subclaims.

Through the fact that the plastics parison, at least the inflatable hollow body region of the plastics parison, is composed of several layers, wherein the layer thicknesses (d1, d2, d3, . . . ) of the individual layers (1a, 1b, 1c, . . . ) only differ slightly from one another taking into consideration the cooling rate of the respective layer (1a, 1b, 1c, . . . ) such that for each of the layers a substantially identical cycle time exists for its production or respectively moulding, a thick-walled plastics parison can be produced by means of the multi-component injection moulding technique with a comparatively short cycle time. This is to be explained by the following example. It is assumed that the wall thickness of the thick-walled preform is 9 mm in the hollow body region. The cycle time for the production in a moulding tool with a cavity for this thick-walled preform is approximately 120 seconds. When the same preform is or is being constructed from three layers with substantially identical layer thickness, the cycle time can be reduced to approximately 20 seconds, because each layer is only approximately 3 mm thick. Only slight differences occur in the individual layer thicknesses, owing to the cooling rate of the respective layer.

A preferred subject of the invention are therefore thick-walled preforms with layer thicknesses of at least approximately 8-10 mm, wherein the individual layers are at least 2 mm, preferably at least 3 mm thick. Particularly preferably, the invention concerns a plastics parison with a mass of at least 300 g, in particular of at least 400 g. This can be a plastics parison for a 5-gallon water container. Basically, however, thick-walled preforms for other large-volume containers also come into consideration. Other large-volume containers can be provided and used for example for filling with wine or with cosmetics. Basically, such large-volume containers can be provided for all kinds of liquid and if applicable also paste-like materials. The essential idea according to the invention therefore resides in dividing the thick-walled preform conceptually into several layers and providing for each of these layers an injection moulding step in a multi-component injection moulding process. The layer thicknesses (d1, d2, d3, . . . ) of the individual layers (1a, 1b, 1c, . . . ) only slightly differ from one another taking into consideration the cooling rate of the respective layer (1a, 1b, 1c, . . . ) such that for each of the layers a substantially identical cycle time exists for its production or respectively moulding. Therefore, different layers can be produced simultaneously in different cavities and can be injected or respectively formed onto the layers respectively formed in the preceding step, wherein substantially the same time is required for each layer.

Depending on the requirements for the finished plastics container, the layers can be made, in the simplest case, of the same plastics material M. If necessary, however, different materials can also be provided for the individual layers. For example, the innermost layer can be made of a new material Mₙ and the further layers can be made of recycled material Mᵣ. In this way, only a comparatively small amount of new material Mₙ is required, which is in contact with the content of the plastics container and economically priced recyclate (Mᵣ) can be used for the further layers.

The thicker the thick-walled plastics parison is, i.e. the greater the wall thickness, it is all the more advisable if this plastics parison is composed of three and more layers. The individual layer thicknesses can differ slightly from one another, taking into consideration the cooling rates and the thermal conductivity of the plastics materials which are used, in order to respectively arrive at the same time for the production of the layer. In particular, the differences should amount to no more than 20%, preferably no more than 10%. Preferably, the following relationship should apply here for the individual layers, following one another from the interior outwards, with regard to their layer thicknesses d₁, d₂, d₃, d₄ and so on: d₁>d₂, d₃≧d₄ . . . . The idea comes into effect here that the first, inner layer is actively cooled from the interior outwards, i.e. the initially injected plastics material is in direct contact, in the interior and exterior, with the cooled moulding tool. In contrast to this, in the subsequent layers only the outer cooling acts directly onto the fresh plastics material, whereas the interior cooling must act through the previously produced layers. To optimize the cycle time, this effect can be taken into consideration insofar as the layer thicknesses are not numerically exactly identically thick from the interior outwards, but rather can have the previously mentioned slight differences.

A suitable injection moulding machine for the production of a plastics parison (preform) according to the invention has at least one plasticizing- and injection unit and a clamping unit equipped with a rotating table or with an indexing plate. Here, parts of a moulding tool are associated with the rotating table or with the indexing plate and these parts can be brought together with further parts of the moulding tool and cavities of differing shape and size can be formed. Several stations can be encountered with the rotating table or with the indexing plate, wherein in different stations cavities of different shape and size can be formed according to the layer of the plastics parison which is respectively to be produced. These cavities with the different shape and size are constructed for the forming of different layers of the plastics parison of respectively substantially identical layer thickness. In addition, a plasticizing- and injection unit is provided for the simultaneous filling of at least two, preferably at least three cavities having respectively different shape and size. A melt distributor system comes into use here, which is arranged between this plasticizing- and injection unit and the previously mentioned cavities. In this way, several layers of the preform can be produced substantially simultaneously by one and the same plasticizing- and injection unit. This results in a distinct reduction of the cycle time, because now a finished thick-walled preform can be ejected or removed after each injection step.

If applicable, in addition a further plasticizing- and injection unit can be provided for the production of one or more layers of the plastics parison. In particular, this additional plasticizing- and injection unit can be provided for the production of the innermost layer. In this case, the melt distributor system would be arranged between the first plasticizing- and injection unit and the cavities for the further layers. In this way, a new material Mₙ can be used for the innermost layer and recycled material Mᵣ for the further layers. If necessary, a melt distributor system can also be provided for the additional plasticizing- and injection unit, in order to be able to produce several different layers of the preform simultaneously.

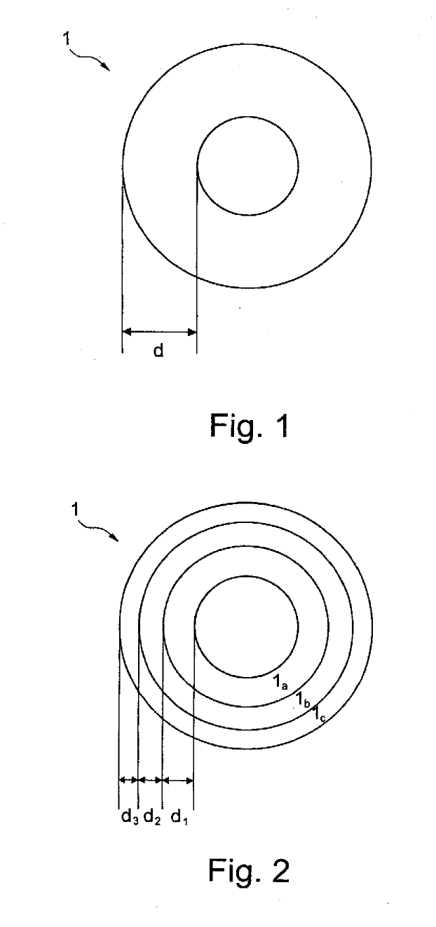

The invention is to be described in further detail below with the aid of an example embodiment and with reference to FIGS. 1 to 4.

FIG. 1 shows diagrammatically a cross-section through the hollow body region of a thick-walled preform 1, which can have, for example, a wall thickness d=9 mm. This is a typical wall thickness of a preform for the production of 5-gallon water containers. According to the invention, this preform 1 is divided conceptually into several layers 1a, 1b, 1c of substantially identical layer thickness d1=d2=d3, as is shown in FIG. 2. With a wall thickness d=9 mm therefore each layer would be 3 mm thick. The multi-layered nature can apply to the entire preform or only to the hollow body region. In order that a substantially identical cycle time exists for the individual layers for the production or respectively moulding thereof, slight differences are present in the layer thicknesses, wherein generally the layer thicknesses decrease from the interior outwards: d1>d2>d3> . . . .

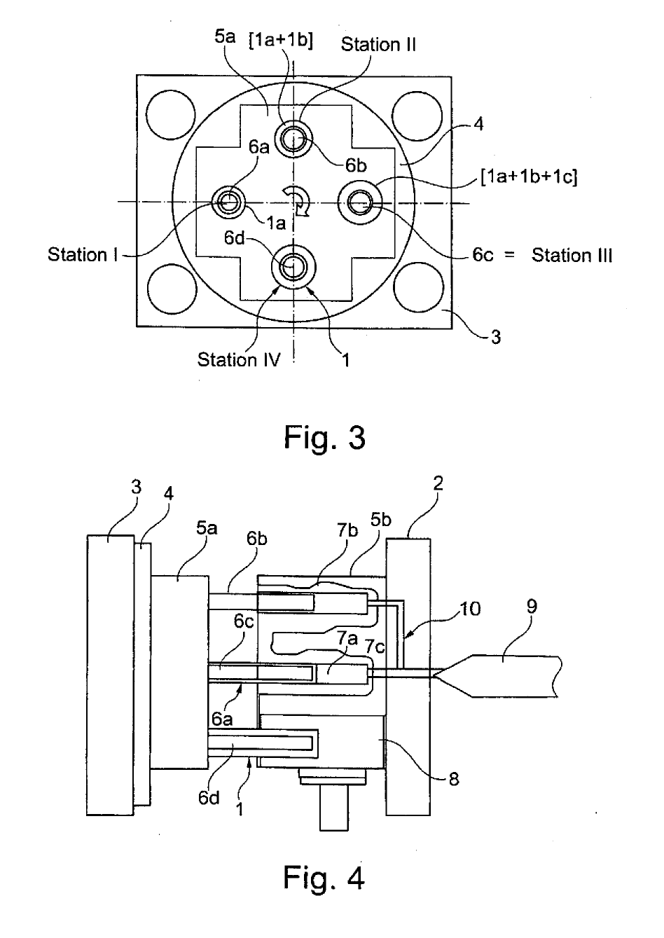

FIGS. 3 and 4 show diagrammatically an injection moulding machine with rotating table technique, as is known, of itself, from multi-component injection moulding, wherein FIG. 3 shows a top view onto the movable mould clamping plate 3 with the rotating table 4, and FIG. 4 shows a side view. The clamping unit has a stationary mould clamping plate 2, a movable mould clamping plate 3 and a rotating table 4 on the movable mould clamping plate 3. A moulding tool for the production of a preform 1 according to the invention comprises a movable mould half 5a with four cores 6a, 6b, 6c and 6d and a stationary mould half 5b. In the stationary mould half 5b three different depressions 7a, 7b and 7c are provided, and a station 8 for cooling the finished preform. The depressions 7a and 7c lie in a plane and therefore one behind the other in the viewing direction. When the cores 6a to 6c are moved into the associated depressions 7a to 7c and the moulding tool 5 is closed, the formation of three different cavities or respectively of three cavities of differing shape and size is brought about in accordance with the layer of the plastics parison 1 which is respectively to be produced. In the station I between the core 6a and the depression 7a the cavity is formed for the first, innermost layer 1a of the preform, in the station II between the core 6b and the depression 7b the cavity for the second layer 1b and in the station III between the core 6c and the depression 7c the cavity for the third layer 1c. The diameter of the depressions 7a to 7c becomes successively larger. With the core moved into these depressions, and with the layers formed thereon, the cavity “migrates” from station I to station II from the interior outwards. Therefore, in the different stations I, II and III cavities of different shape and size are formed in accordance with the layer of the plastics parison which is respectively to be produced, wherein these cavities are constructed with the different shape and size for forming the different layers of the plastics parison of respectively substantially identical layer thickness, namely for forming the first layer (1a) in station I, the second layer (1b) in station II and the third layer (1c) in station III. The core 6d is situated in station IV with the finished injected plastics parison 1 with all three layers d1-d3 injected over one another and adjacent to one another, and can be cooled down to a suitable demoulding temperature in a cooling station 8.

After removal of the finished preform 1 from the core 6d, the rotating table can be advanced through 90° and the moulding tool can be closed again. Thereafter, the core 6d which is now free is situated in the depression 7a, the core 6a with the first layer 1a in the depression 7b, the core 6b with the layers 1a+1b in the depression 7c and the core 6c with the layers 1a+1b+1c in the cooling station 8. Now, but means of the plasticizing- and injection unit 9, which is only indicated here, and with a suitable melt distributor 10, plastics material M can be injected again into the cavities in the stations I, II and III and these cavities can be filled simultaneously. After the necessary cooling time, the moulding tool 5 can be opened again, the finished preform 1 can be removed from the core 6c and the rotating table can be advanced again through 90°. The above-mentioned steps are repeated successively, so that the cores 6a-6d with the part of the preform 1 respectively situated thereon are advanced respectively through 90° until a finished preform 1 can be removed in station IV. Through the simultaneous filling of the cavities in the stations I, II and III with the same material M, a finished thick-walled preform 1 of the material M can be removed at the station IV after each injection step, i.e. after each shot.

In a further embodiment, not illustrated here, an additional plasticizing- and injection unit can be provided, in order to produce the first inner layer 1a with a first material, e.g. new material Mₙ. The plasticizing- and injection unit 9 with the melt distributor 10 then serves once more for the production of the subsequent layers 1b and 1c with a different material, e.g. recycled material Mᵣ.

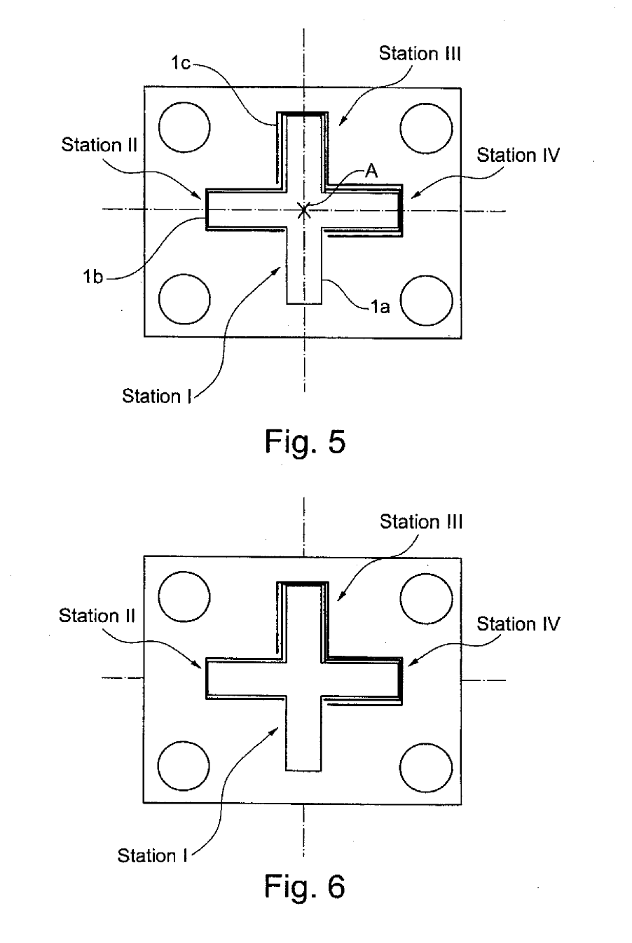

Instead of the rotating table technique described here, the so-called indexing plate technique can also be used, in order to form the cavities of differing shape and size in accordance with the layer of the plastics parison which is respectively to be produced. FIG. 5 shows diagrammatically the indexing plate technique for the production of a PET preform with three layers 1a, 1b and 1c from the same material M. An indexing plate 11 with four arms 12 is rotatable between two mould clamping plates and a tool about an axis A. In the four stations, cavities are formed in succession, configured for the formation or respectively moulding of the respective layer. The innermost layer is produced in station I on the arm, i.e. the first layer of PET material is injected onto this arm or respectively core. In station II the first layer is covered by the second ply or respectively the second layer of PET material, and in station III the third layer of PET material is added. In station IV the finished, thick-walled preform can cool and can be removed in the next cycle. The layer thicknesses in the individual stations differ only slightly and in fact such that, taking into consideration the cooling rates in each of the stations I, II and III, substantially the same time exists for the production and moulding of the respective layer. At the end of the production process, therefore, a thick-walled PET preform of one and the same material is present (so-called 1-phase preform), which is composed of several layers 1a, 1b, and 1c, in an analogous manner to the illustration in FIG. 2, wherein the layer thicknesses d1, d2 and d3 of the individual layers 1a, 1b and 1c only differ slightly from one another, taking into consideration the cooling rate of the respective layer, and in fact such that for each of the layers 1a, 1b and 1c a substantially identical cycle time exists for their production or respectively moulding. Different materials can also be provided for the individual layers 1a, 1b, 1c, FIG. 6 shows diagrammatically the production of a thick-walled preform of three layers 1a, 1b and 1c, wherein between the two layers 1a and 1c of PET material, a layer 1b of a material with barrier characteristics is embedded. The same applies to the individual layer thicknesses d1, d2 and d3 as in the case of the use of the same material, wherein, however, the cooling rate of the plastics material with the barrier characteristics must be taken into consideration. In any case, in the present case, it also applies that the layer thicknesses d1, d2 and d3 of the individual layers 1a, 1b and 1c only differ slightly from one another, taking into consideration the cooling rate of the respective layer, and in fact such that for each of the layers 1a, 1b and 1c a substantially identical cycle time exists for their production or respectively moulding.

Whereas in the present example embodiments the thick-walled preform has been divided into three layers, a division into two or into more than three layers can be carried out. It is only essential that the layer thicknesses of the individual layers are coordinated with one another such that in each station substantially the same cycle time exists. In other words, for each of the layers substantially the same time is to exist for their production or respectively moulding. The cycle time—apart from the time for the injecting of the melt—is determined substantially by the cooling time tCool, which is required for the respective layer, until the tool can be advanced and sent to the next step of the cycle. The wall thickness, here therefore the layer thickness, goes quadratically into the cooling time. The following relationship applies for laminar articles:

Laminar articles (wall thickness s)

$${t}_{cool} = \frac{{s}^{2}}{{π}^{2} \cdot {a}_{eff}} \cdot ln ( \frac{8}{{π}^{2}} \cdot \frac{{T}_{M} - {T}_{W}}{{T}_{E} - {T}_{W}} )$$

s=wall thickness [mm]
a_{eff}=effective heat transmission [mm²/s]
T_{M}=mass temperature [° C.]
T_{W}=tool wall temperature [° C.]
T_{E}=demoulding temperature [° C.]

In conclusion, it is to be stated that for the number of layers a number n of layers adapted to the respective conditions, basically not subject to an upper limit, can be provided. For production by means of the above-mentioned rotating table or indexing plate technique a corresponding number n+x is to be provided, wherein x is to be the number of stations which are provided for the cooling of the finished preforms. In the embodiments described above, n=3 and x=1.

Finally, the invention is not limited to the use of particular materials. The plastics parison (preform) according to the invention can be constructed from the most varied of materials and material combinations. In particular, one or more barrier layers can be provided. For example, a finished preform could be constructed from the following materials (sequence from the interior outwards): PET, PA, EVOA, PET, . . . . Moreover, recylate of any desired materials or respectively materials suitable for the respective intended use can also be provided. Care should merely be taken that for the individual layer thicknesses a substantially identical time exists for their production or respectively moulding, so that by means of the multi-component injection moulding technique the individual layers can be produced simultaneously and for each cycle substantially the same time is required and an unnecessary “waiting time” does not exist in any of the stations which has a negative effect on the cycle time as a whole.

### LIST OF REFERENCE NUMBERS

1 preform
1a innermost layer
1b middle layer
1c outer layer
2 stationary mould clamping plate
3 movable mould clamping plate
4 rotating table
5 moulding tool
5a movable mould half
5b stationary mould half
6a-6d cores
7a-7c depressions
8 cooling station
9 plasticizing- and injection device
10 melt distributor
11 indexing plate
12 arm or respectively core

What is claimed is:

1.-16. (canceled)

17. A preform of an inflatable large-volume container, said preform comprising a closure region and an inflatable hollow body region, at least said inflatable hollow body region being formed by multiple layers, each defined by a layer thickness, wherein the layer thicknesses differ as a function of a cooling rate of the layers within a range to allow production or forming of the layers within a substantially same cycle time.

18. The preform of claim 17, wherein the layer thickness of each layer is at least 2 mm.

19. The preform of claim 17, wherein the layer thickness of each layer is at least 3 mm.

20. The preform of claim 17, wherein an innermost one of the layers is made of a new material, and remaining ones of the layers are made of recycled material.

21. The preform of claim 17, wherein the inflatable body has at least three layers.

22. The preform of claim 17, wherein layer thicknesses of the layers applied in succession from inside to outside thicknesses are defined by the following relationship:
d1>d2≧d3≧d4
wherein d1 is the layer thickness of an innermost one of the layers, and d2, d3 and d4 are the layer thicknesses of the remaining layers positioned above the innermost layer toward the outside.

23. The preform of claim 22, wherein the layer thicknesses of the layers differ no more than 10%.

24. The preform of claim 22, wherein the layer thicknesses of the layers differ no more than 20%.

25. The preform of claim 17, having a mass of at least 300 g.

26. The preform of claim 17, constructed to form a water container having a volume of 1 gallon, 3 gallons, 5 gallons or more than 5 gallons.

27. A method for producing a preform having multiple layers, comprising forming a layer in each of a plurality of successive cavities by filling the cavities with plastic melt for producing at least a hollow body region of a preform, with a first one of the cavities forming an innermost one of the layers defined by a layer thickness, and with the successive cavities being sized to form the remaining layers such that each of the remaining layers is moulded onto a preceding one of the layers and is defined by a layer thickness, wherein the layer thicknesses of the layers differ as a function of a cooling rate of the layers within a range to allow production or forming of the layers within a substantially same cycle time.

28. The method of claim 27, wherein a same plastic material is used for each of the layers.

29. The method of claim 27, wherein a new material is used for the innermost layer, and wherein a recycled material is used for each remaining layer.

30. The method of claim 27, wherein the at least hollow body has three layers.

31. The method of claim 27, wherein the cavities are filled with plastic melt sufficient to produce each layer with a mass of at least 75 g.

32. The method of claim 27, wherein the cavities are filled with plastic melt sufficient to produce each layer with a mass of at least 100 g.

33. An injection moulding machine for producing a preform, comprising:
a clamping unit having a rotating table and a moulding tool provided with a first mould part which is operably connected to the rotating table and interacts with a second mould part of the moulding tool to allow formation of plural cavities of different size and shape as the rotating table is rotated into various stations and formation of successive layers in the plural cavities to thereby define an innermost layer and remaining layers applied there above and moulded onto a preceding one of the layers, said plural cavities being sized such that the plural layers have layer thicknesses which differ as a function of a cooling rate of the layers within a range to allow production or forming of the layers within a substantially same cycle time;
a plasticizing and injection unit constructed to inject plastic melt into at least two of the plural cavities at a same time; and
a melt distribution system arranged between the plasticizing and injection unit and the plural cavities.

34. The injection moulding machine of claim 33, wherein the rotating table is configured as an indexing plate.

35. The injection moulding machine of claim 33, wherein the plasticizing and injection unit is constructed for simultaneous injection of plastic melt into at least three of the plural cavities.

36. The injection moulding machine of claim 33, further comprising a further plasticizing and injection unit for producing one or multiple ones of the layers of the preform.

37. The injection moulding machine of claim 36, wherein the further plasticizing and injection unit is constructed for producing the innermost layer of the preform.
